(19) United States
(12) Patent Application Publication
(10) Pub. No.: US 2006/0010069 A1
(43) Pub. Date: Jan. 12, 2006

(54) Transaction support method and system using same

(76) Inventor: Shinichi Yamazaki, Tokyo (JP)

Correspondence Address: RABIN & BERDO, P.C., Suite 500, 1101 14th Street, Washington, DC, 20005, US

(21) Appl. No.: 11/110,925

(22) Filed: Apr. 21, 2005

(30) Foreign Application Priority Data
Jul. 12, 2004 (JP) 2004-204100

(51) Int. Cl. G06Q 40/00; G06F 17/00

(52) U.S. Cl. 705/39; 707/100

(57) ABSTRACT

Disclosed is a transaction support method and system of supporting a transaction by controlling opening/closing of a plurality of lockers in order to deliver and receive an article related to the transaction. The transaction support method includes preparing each of the plurality of lockers as a safe, determining whether or not a client is an authorized client based on pre-stored client-related information in accordance with a transaction request from the client, assigning one of the safes as an assignment safe to the client if it is determined that the client is an authorized client, and unlocking the assignment safe.

### BACKGROUND OF THE INVENTION

1. Field of the Invention

The present invention relates to a transaction support method and system for supporting commercial transactions by controlling a plurality of storage boxes (hereinafter, referred to as “lockers”), which are distributed at locations remote from commercial transaction locations in order to deliver and receive articles related to the transaction operates over a communication network, and more particularly relates to a transaction support and system, which is adapted to financial transactions.

2. Description of the Related Art

In connection with commercial transactions, for example, Japanese Patent Application Kokai No. 2002-269467 discloses an electronic shopping system wherein ordered commodities are delivered to a locker provided at a site specified by a user ordering the commodities and the user receives the ordered commodities from the locker by using a key previously acquired.

However, transactions at business offices of financial institutions are being commonly processed when a bankbook or slip in which items are entered by a client who comes to the business offices is presented to a bank window, and a bank clerk called a teller operates a terminal to process the bankbook or the slip based on the entered items.

However, recently, as the number of business offices has been decreased due to the merger and abolition of financial institutions, the number of clients who come to one business office to conduct transactions such as transfer, deposit and withdrawal, or various notifications has increased. Owing to the increase of the amount of businesses of the business offices, it is difficult for the financial institutions to exclusively use personnel necessary for businesses such as financial consultations to make more profits, which results in deterioration of management efficiency. In addition, the clients are forced to wait at the bank windows for longer periods.

### SUMMARY OF THE INVENTION

Accordingly, it is an object of the present invention to provide a transaction support method and system for enhancing business processing efficiency of financial institutions and shortening waiting periods of clients.

The present invention provides a transaction support method for supporting a transaction by controlling opening/closing of a plurality of lockers in order to deliver and receive articles related to the transactions, the transaction support method comprising a safe preparation step of preparing each of the plurality of lockers as a safe, a client determination step of determining whether or not a client is an authorized client based on pre-stored client-related information in accordance with a request for transaction from the client, a safe assignment step of assigning one of the plurality of safes as an assignment safe to the client if it is determined that the client is an authorized client, and an unlock step of unlocking the assignment safe.

The present invention provides a transaction support system for supporting a transaction by controlling opening/closing of a plurality of lockers in order to deliver and receive articles related to the transaction, comprising safe accommodation means for accommodating each of the plurality of lockers as a safe, client determination means for determining whether or not a client is an authorized client based on pre-stored client-related information in accordance with a request for transaction from the client,safe assignment means for assigning one of the plurality of safes as an assignment safe to the client if it is determined that the client is an authorized client, unlock means for unlocking the assignment safe, and lock means for locking the assignment safe in accordance with putting/taking the articles related to the transaction in/out of the assignment safe.

With the transaction support method and system according to the present invention, articles related to transactions can be delivered and received through safes controlled by a computer. Accordingly, since there can be provided a time difference in contact between clients and business process sides, for example, it is possible to delay time for transferring of the articles to the clients, thus allowing concentration of business processes in financial institutions. In addition, by dealing with corporate clients to whom most of the bank window processes are dedicated according to the method of the invention, high efficiency of the business processes of business offices can be attained.

### BRIEF DESCRIPTION OF THE DRAWINGS

FIG. 1 is a block diagram illustrating an entire configuration of a system according to a first embodiment of the present invention;

FIG. 2 is a block diagram illustrating a detailed configuration of a safe shown in FIG. 1;

FIG. 3 is a block diagram illustrating a detailed configuration of a safe management server shown in FIG. 1;

FIGS. 4A to 4C are explanatory diagrams illustrating examples of configuration of a client information database, a collection and delivery agency information database, and a progress information database, respectively, which are shown in FIG. 3;

FIG. 5 is a sequence diagram illustrating a processing procedure of the entire system in a transaction start phase;

FIG. 6 is a sequence diagram illustrating a processing procedure of the entire system in a collection phase;

FIG. 7 is a sequence diagram illustrating a processing procedure of the entire system in a business processing phase;

FIG. 8 is a sequence diagram illustrating a processing procedure of the entire system in a delivery phase;

FIG. 9 is a sequence diagram illustrating a processing procedure of the entire system in a transaction termination phase;

FIG. 10 is a perspective view illustrating an example of a modified safe apparatus in which articles in custody to be stored in individual safe lockers are stored in a storage bag;

FIG. 11 is a perspective view illustrating an example of a modified safe apparatus in which individual safe lockers can be freely transported; and

FIG. 12 is a perspective view illustrating an example of a modified safe apparatus in which the storage bag shown in FIG. 10 is delivered and taken.

### DETAILED DESCRIPTION OF THE INVENTION

Hereinafter, embodiments of the invention will be described with reference to the accompanying drawings.

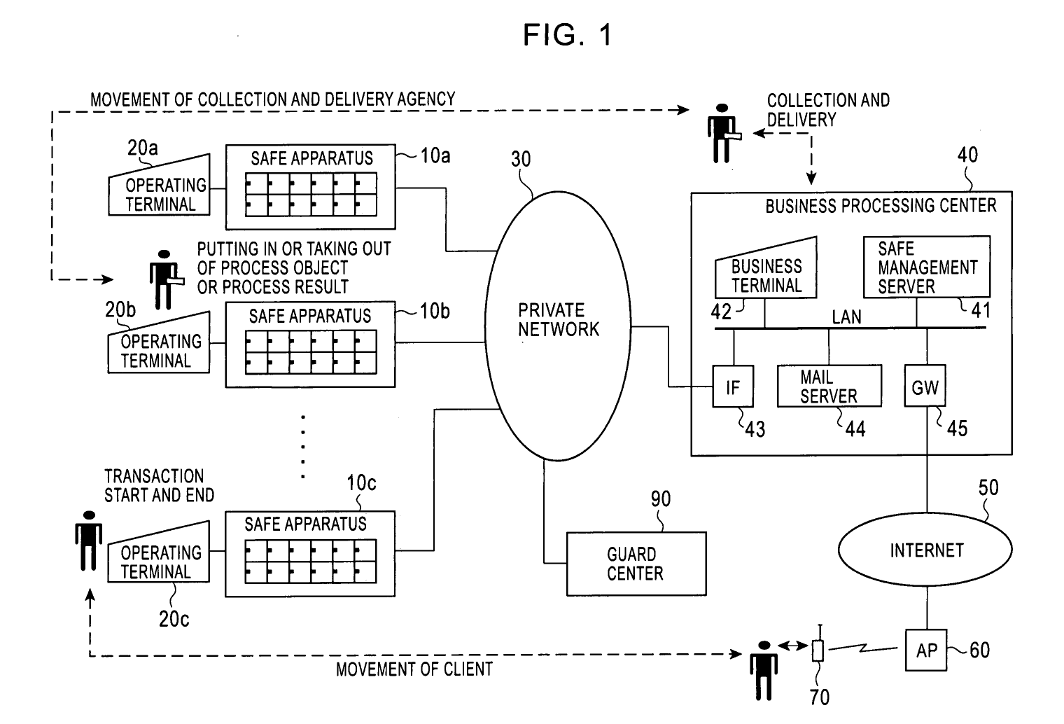

FIG. 1 is a block diagram illustrating an entire configuration of a system according to a first embodiment of the invention. As shown in the figure, a plurality of safe apparatuses 10a to 10c are connected to a business processing center 40 via a dedicated network 30. Each of the plurality of safe apparatuses 10a to 10c is a compound apparatus including a plurality of safe lockers and computers for electronically controlling the plurality of safe lockers, respectively, and conducting data communication with the business processing center 40. The plurality of safe apparatuses 10a to 10c are connected respectively to a plurality of operating terminals 20a to 20c for opening/closing and locking the safes based on operating commands from users and inputting transaction request information.

Typically, the plurality of safes 10a to 10c are placed at business offices distributed in a business area under the jurisdiction of the business processing center 40 in such a manless circumstance that clients are freely accessible to their own safes. A guard center 90 is connected to the dedicated network 30 for performing guard tasks through calls in case of emergency or monitoring by remotely operated cameras provided in the business offices. Thus, security of the plurality of safes 10a to 10c can be assured.

The business processing center 40 includes a safe management server 41 for managing all the safes 10a to 10c, a business terminal 42, a network interface (IF) 43 for enabling data communication via the dedicated network 30, a mail server 44, a network gateway (GW) 45 for enabling data communication via Internet 50, which are interconnected via a local area network (LAN).

The business processing center 40 is a center for processing various businesses in financial transactions that are equivalent to businesses of branch offices of a typical financial institution. Such business process includes various financial transaction businesses, such as a loan process, a bill discount process, a foreign exchange rate process, a process related to export-import letter of credit, a transfer process, or a cash or check deposit and withdrawal process. These business processes always require manpower, for example, in that documentation is requisite for a bill in the bill discount business. Progress information on these business processes is inputted to the safe management server 41 through the business terminal 42 by a bank clerk. The mail server 44 serves to transmit mail to a client based on the progress information stored in the safe management server 41. The mail including the progress information is delivered to a portable telephone 70 carried by the client via an access point (AP) 60 over the Internet 50 for a portable telephone.

Next, operation of the system shown in FIG. 1 will be described. First, as a transaction start phase, it is assumed that a client of a financial institution wishes to draw out cash from a business office of the financial institution. The client operates the operating terminal 20 to store an object of the business process (hereinafter, referred to as a “process object”) including cash and a deposit slip in one safe locker of the safe apparatus 10. At this time, the client may freely leave the business office, with the receipt transaction put in charge of the business office.

On the other hand, as a collection phase, a collection and delivery agency collects process objects while he makes the round of business offices at which the safe apparatuses 10a to 10b are installed, on a regular basis or depending on whether or not the process objects are stored. Opening/closing and locking of the safes is secured by performing an authentication on whether or not the collection and delivery agency is authorized. The collection and delivery agency delivers all of the process objects collected from the safes to the business processing center 40.

Next, as a business processing phase, business processes corresponding to the process objects is performed in the business processing center 40. Results of the business processes, for example, documents, such as receipt slips, indicating money receipt completion, or cash by refund (hereinafter, referred to as “process results”), are provided for each transaction.

Next, as a delivery phase, the collection and delivery agency collects the process results provided for each transaction in the business processing center 40 and delivers again them to the safe apparatuses 10a to 10c. In the course of the above-described procedures, a series of business progresses including the collection of the process objects by the collection and delivery agency, the business process of the collected process objects by the bank clerk in the business processing center 40, and the collection and re-storage of the process results in the safes by the collection and delivery agency is reported to the client's portable telephone 70 via electronic mail through an electronic process performed in cooperation among the safe management server 41, the business terminal 42 and the mail server 44.

Finally, as a transaction termination phase, after the client receives the electronic mail informing of the re-storage of the process results in the safes, he again visits the business office and receives the remaining process results such as the receipt slip corresponding to a deposit request to complete a series of transactions.

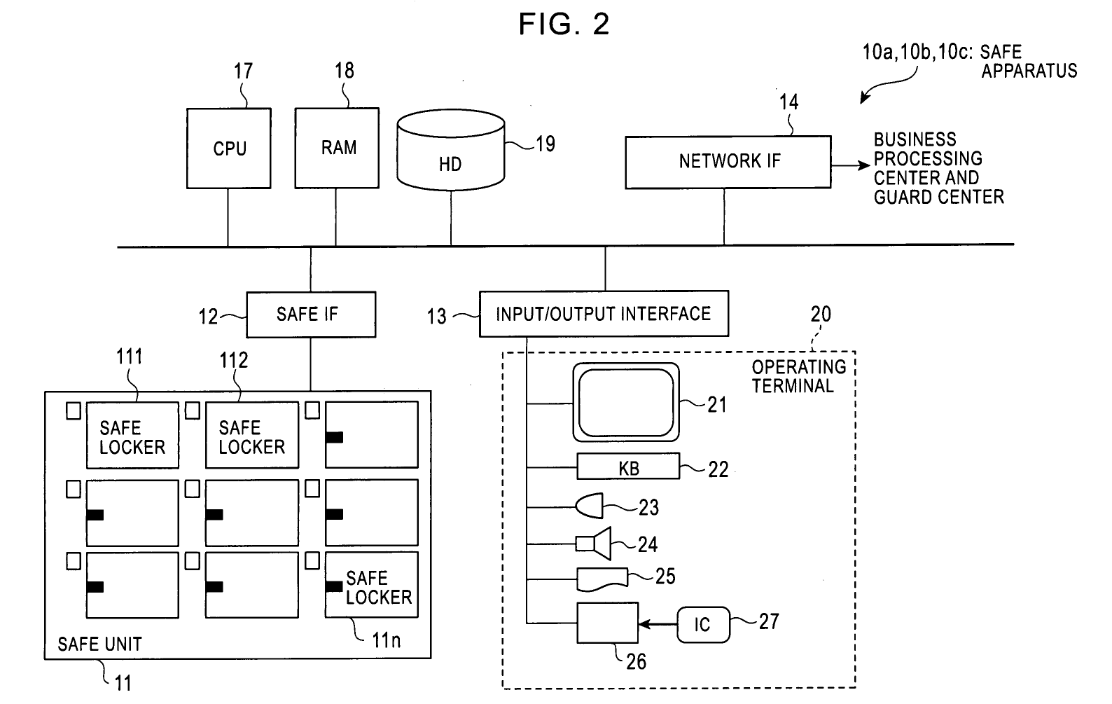

FIG. 2 is a block diagram illustrating a detailed configuration of a safe shown in FIG. 1. Each of the safe apparatuses 10a to 10c includes a CPU 17, a memory 18, a hard disk 19, a network interface (IF) 14, a safe interface (IF) 12, and an input/output interface (IF) 13, which are interconnected via a common bus in order to configure a typical computer, and a safe unit 11 is connected to the safe interface (IF) 12. Each of the safe apparatuses 10a to 10c is connected to an operating terminal 20 via the input/output interface (IF) 13. The safe unit 11 is composed of a plurality of safe lockers 111 to 11n. Each of the plurality of safe lockers 111 to 11n is individually and electrically locked and unlocked based on a command from the CPU 17. Each of the plurality of safe lockers 111 to 11n has a function of detecting the presence or absence of articles stored therein based on an infrared ray detection system and informs the CPU 17 of the presence or absence of the articles. Each of the safe lockers 111 to 11n may be manually or automatically opened or closed. Also, each of the safe lockers 111 to 11n may include respective readers/writers for providing communication with IC tags. The IC tags are attached to the articles or storage bags accommodating the articles. The readers/writers can read information recorded in the IC tags or record information in the IC tags. The information recorded in the IC tags may include, for example, a consignment number, a client number, a client mail address, a location of a using safe, etc.

The operating terminal 20 includes a display unit 21 which compose a touch panel, a keyboard (KB) 22, a microphone 23 for allowing conversation with security personnel of a guard center, a speaker 24 for announcing voice guidance and the like, and a printer 25 for outputting a deposit slip on which the consignment number and the like are printed. Also, the operating terminal 20 may further include a card reader/writer 26 for reading/writing information from/on a magnetic card or an IC card 27 of the client. In addition, the operating terminal 20 may further include a bio-information input apparatus (not shown) used to identify individuals by using bio-information such as an iris recognition or a fingerprint of the client.

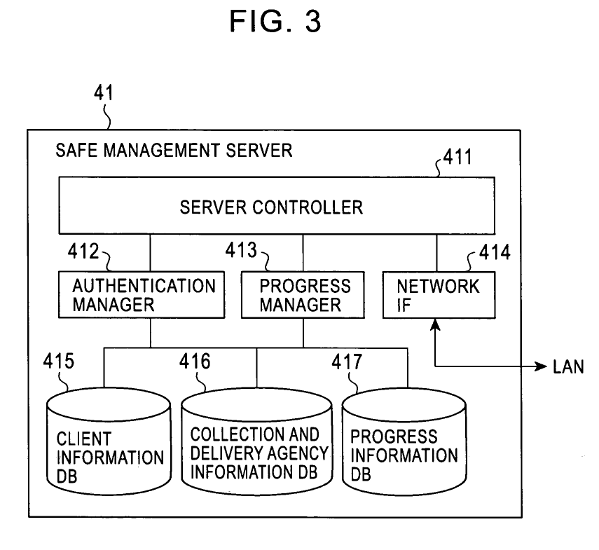

FIG. 3 is a block diagram illustrating a detailed configuration of a safe management server shown in FIG. 1. The safe management server 41 is configured by a typical server computer. As shown in the figure, a software configuration of the safe management server 41 includes a server controller 411 for performing a basic control of a computer, a network interface (IF) 414 for communicating with sections within the business processing center, an authentication management unit 412, and a progress management unit 413.

The authentication management unit 412 serves to certify whether or not a client or a collection and delivery agency is authorized to open/close the safe in response to a request for transaction or operation from the client or the collection and delivery agency with reference to a client information database 415 and a collection and delivery information database 416. The progress management unit 413 serves to manage a series of progress information related to the transaction start, warehousing of the process objects in the safes, the collection of the process objects by the collection and delivery agency, the business process of the collected process objects in the business processing center, and the collection of the process results in the safes, and the receipt of the process results by the clients by storing and updating a series of progress information in a progress information database 417. The progress management unit 413 serves to deliver mail reporting the progress information to the clients to the mail server via the network interface 414 at a predetermined timing.

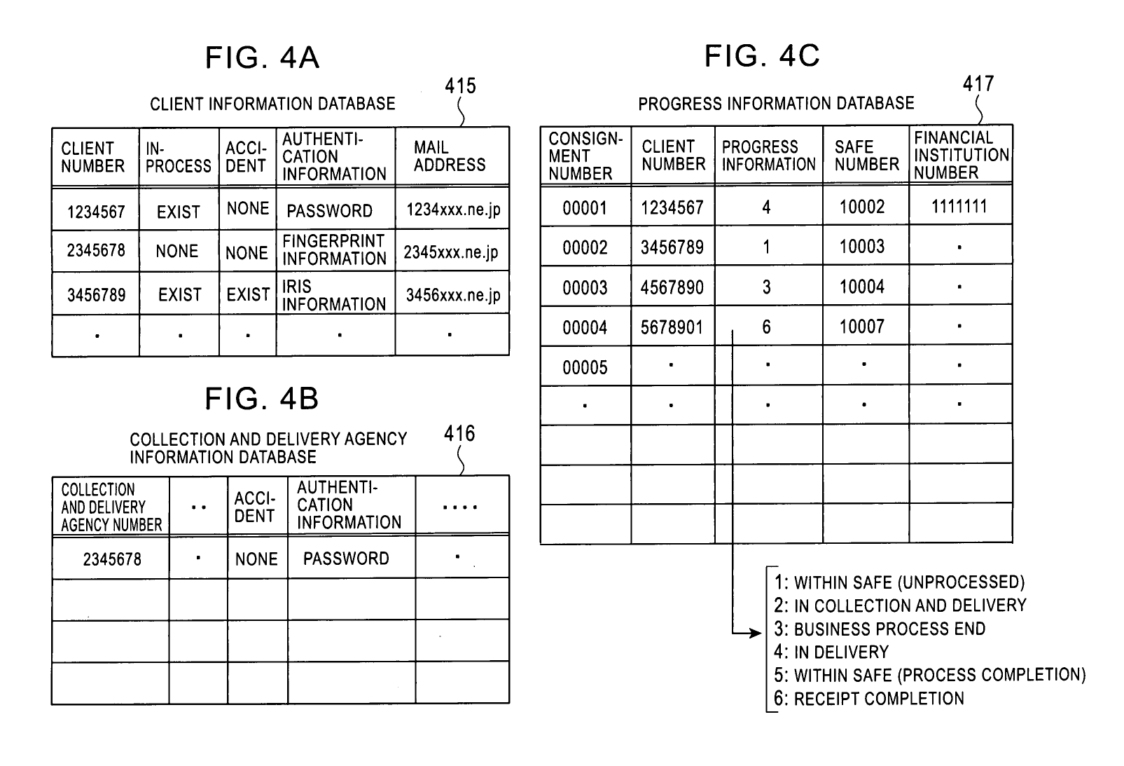

FIGS. 4A to 4C are explanatory diagrams illustrating examples of configuration of the client information database, the collection and delivery agency information database, and the progress information database, respectively, which are shown in FIG. 3. The client information database 415 includes ‘client number’ for identifying clients, ‘in-process’ for indicating information indicating whether or not a transaction is present, ‘accident’ for indicating accident information such as the loss of articles, ‘authentication information’ for giving link information accessible to bio-information files or passwords themselves, and ‘mail address’ of clients. The collection and delivery information database 416 includes ‘collection and delivery agency number’ for identifying collection and delivery agencies, ‘accident’ for indicating accident information such as the loss of articles, ‘authentication information’ for providing link information accessible to bio-information files or passwords themselves. Information of ‘accident’ means occurrence of accidents related to transaction procedures. In this case, there may be provided a difference service level for a subsequent transaction.

The progress information database 417 includes a plurality of entries for every transaction, each of which is composed of ‘consignment number’ for identifying individual transactions, ‘client number’ for identifying clients, ‘progress information’ for giving information on progress conditions of transactions, and ‘safe number’ used for transactions. The ‘progress information’ may be represented as numerical values, as shown in the figure, such as ‘1. within the safe (unprocessed)’, ‘2. in collection and delivery’, ‘3. business process end’, ‘4. in delivery’, ‘5. within the safe (process completion)’, and ‘6. receipt completion’. In addition, by preparing ‘consignment number’ for identifying transactions, not only individual transactions can be identified but also a plurality of transactions for one client can be conducted. In addition, as shown in the figure, by providing ‘financial institution number’ in the progress information database 417 and assigning a plurality of financial institutions for each transaction, a common safe can be provided, which will be described later.

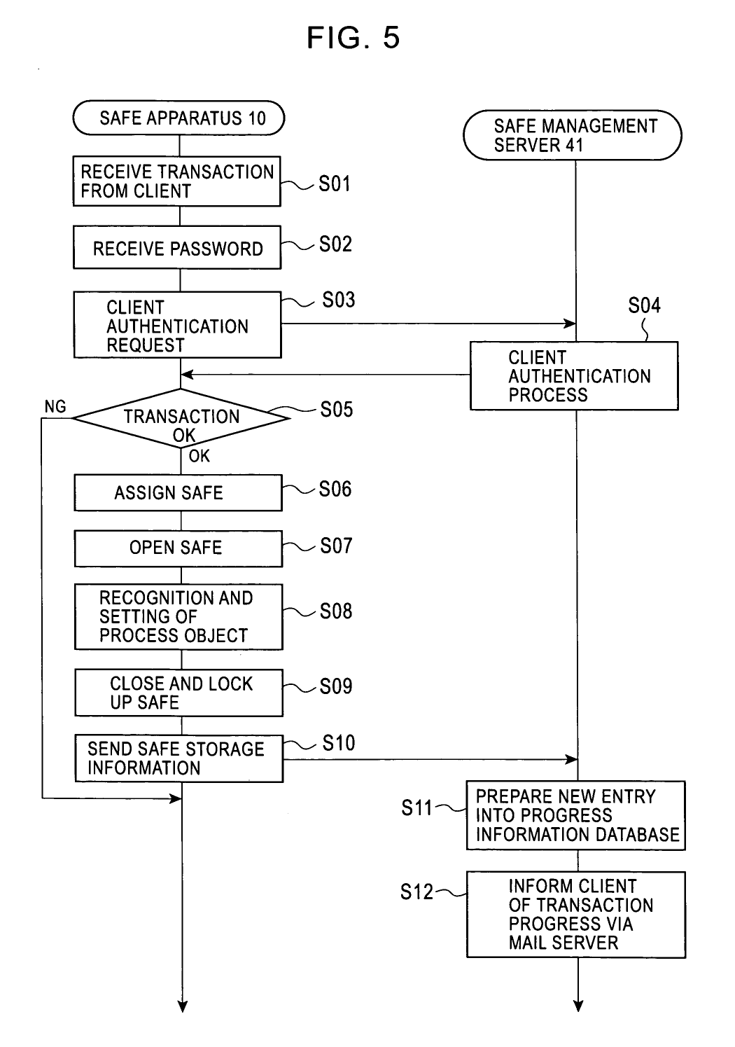

FIGS. 5 to 9 show process procedures in this embodiment of the invention. Hereinafter, these process procedures, which are divided into five phases, that is, a transaction start phase, a collection phase, a business processing phase, a delivery phase, and a transaction termination phase, will be described. In these figures, process procedures for operation of one safe apparatus 10 representative of the safe apparatuses 10a to 10c in association with the safe management server 41 are shown in a sequence.

FIG. 5 illustrates a processing procedure of the entire system in the transaction start phase by a client. Referring to the figure, first, the safe apparatus 10 receives a transaction from a client according to request for the transaction from the client (Step S01). The transaction request from the client is recognized through a slip entry operation using a touch panel connected to the safe apparatus 10. Instead of the slip entry operation, the transaction request may be recognized through a magnetic card or an IC card given to the client in advance. Subsequently, the safe apparatus 10 prompts the client to input his password and receives the password (Step S02). Subsequently, the safe apparatus 10 sends a client number and the password to the safe management server 41 in order to request a client authentication (Step S03).

According to this request, the safe management server 41 performs a client authentication process with reference to the password of authentication information corresponding to the client number included in the client information database and informs the safe apparatus 10 of a result of the client authentication process (Step S04). Various methods for the client authentication process may be used in addition to a password method. For example, by holding a fingerprint information file or an iris recognition information file in the authentication information of the client information database and sending a fingerprint or an iris of the client obtained in the safe apparatus 10 to the safe management server 41, the client can be authenticated as an authorized client.

According to the result of the authentication process from the safe management server 41, the safe apparatus 10 determines whether the transaction is accepted (OK) or not (NG) (Step S05). If the authentication result is NG, subsequent steps are skipped to stop the process procedure. On the contrary, if the authentication result is OK, the safe apparatus 10 assigns one of the plurality of safe lockers to the client (Step S06). Subsequently, the assigned safe locker is unlocked according to an electrical command and a door of the safe locker is opened (Step S07). The client puts things necessary for transactions, i.e., the process objects, into the opened safe locker.

When the process objects are put into the safe locker, the safe apparatus 10 checks whether the process objects are correctly put in the safe locker using a detecting means such as an infrared ray sensor (Step S08). At this time, using a reader/writer for writing information in an IC tag or reading information from the IC tag, information such as a consignment number for identifying transactions, a client number, a client mail address, a location of a safe used, a safe number, etc., may be recorded in the IC tag attached in any form to the process objects. Subsequently, the safe locker is closed and locked according to an electrical command (Step S09). If the process objects are incorrectly put into the safe locker, the safe apparatus 10 preferably prompts the client to try again to put the process objects into the safe locker, using means such as a voice guidance. At this time, a consignment slip in which the information such as the consignment number for identifying transactions, the client number, the location of the safe used, the safe number, etc., is recorded and may be outputted. Next, the safe apparatus 10 sends safe storage information to the safe management server 41 (Step S10). The safe storage information includes the client number and the safe number specifying a safe locker.

The safe management server 41 creates a new entry for a new transaction in the progress information database based on the safe storage information received from the safe apparatus 10 (Step S11). As the new entry, ‘consignment number’ for identifying transactions is set, and ‘client number’ and ‘safe number’ being used for a transaction being currently conducted are extracted and set from the received safe storage information, and ‘progress information’ as the information on progress conditions of transactions is set as ‘1. within the safe (unprocessed)’. Subsequently, the safe management server 41 informs the client of the transaction progresses via the mail server (Step S12). In this case, the safe management server 41 recognizes a mail address corresponding to the client number with reference to the client information database and sends a mail including the progress information in the progress information database to thereby complete report of the progress information. In other words, a receiving location of the mail is a mail address of the client corresponding to the consignment number and the content of the mail is ‘within the safe (unprocessed)’.

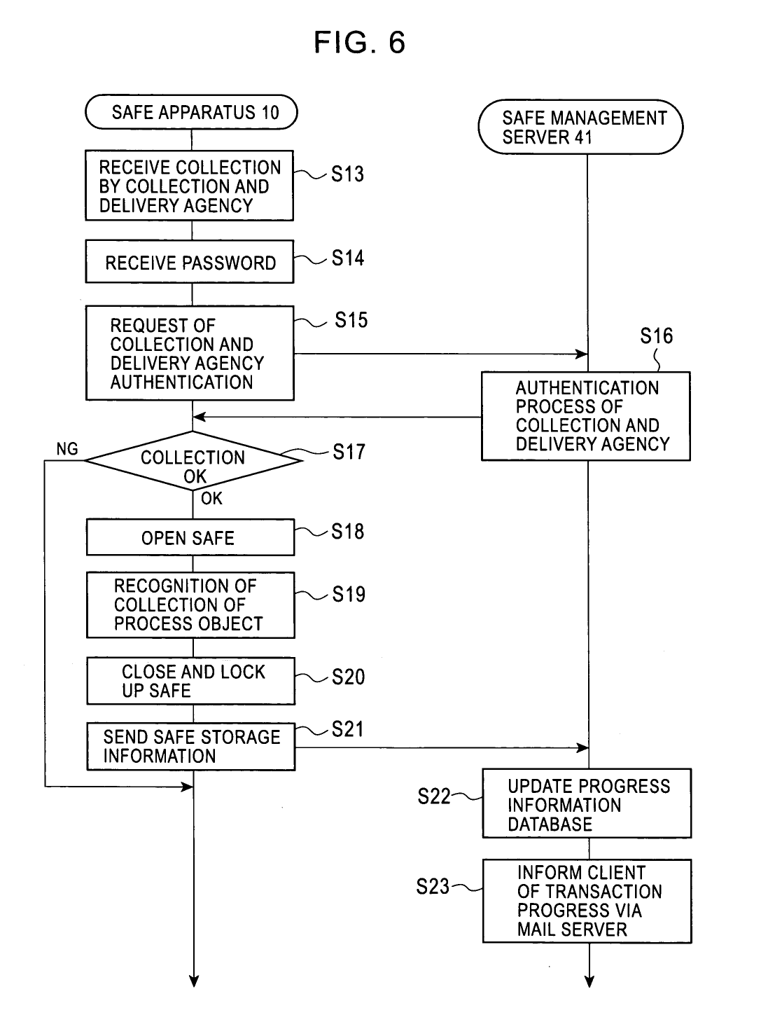

FIG. 6 illustrates a processing procedure of the entire system in a collection phase by the collection and delivery agency. Referring to the figure, first, the safe apparatus 10 receives collected articles from the collection and delivery agency according to collection notification from the collection and delivery agency (Step S13). The collection notification from the collection and delivery agency is recognized through a collection notification operation using the touch panel connected to the safe apparatus 10. Instead of the collection notification operation, the collection notification request may be recognized through a magnetic card or an IC card given to the collection and delivery agency in advance. Subsequently, the safe apparatus 10 prompts the collection and delivery agency to input his password and receives the password (Step S14). Subsequently, the safe apparatus 10 sends a collection and delivery agency number and the password to the safe management server 41 in order to request a collection and delivery agency authentication (Step S15).

According to this request, the safe management server 41 performs a collection and delivery agency authentication process with reference to the password of authentication information corresponding to the collection and delivery agency number included in the collection and delivery agency information database and informs the safe apparatus 10 of a result of the collection and delivery agency authentication process (Step S16). Methods of the collection and delivery agency authentication process may include various methods in addition to a password method in the same way as the client authentication process. For example, by holding a fingerprint information file or an iris recognition information file in the authentication information of the collection and delivery agency information database and sending a fingerprint or an iris recognition of the collection and delivery agency obtained in the safe apparatus 10 to the safe management server 41, the collection and delivery agency can be authenticated as an authorized collection and delivery agency.

According to the result of the authentication process from the safe management server 41, the safe apparatus 10 determines whether the collection is accepted (OK) or not (NG) (Step S17). If the authentication result is NG, subsequent steps are skipped to stop the collection. On the contrary, if the authentication result is OK, the safe apparatus 10 unlocks only a safe box containing the process objects or all safe lockers according to an electrical command and opens a door of the safe locker (Step S18). The collection and delivery agency takes the process objects out of the opened safe locker. The process objects are collected in the unit of transaction, i.e., the unit of consignment number. At this time, using a reader/writer for writing information in an IC tag or reading information from the IC tag, the process objects can be easily identified by reading the consignment number from the IC tags attached to the process objects.

When the process objects are taken out of the safe locker, the safe apparatus 10 checks whether the process objects are correctly taken out from the safe locker using a detecting means such as an infrared ray sensor (Step S19). Subsequently, the safe locker is closed and locked according to an electrical command (Step S20). If the process objects are incorrectly taken out of the safe locker or any process objects remain in the safe locker, preferably, the safe apparatus 10 prompts the collection and delivery agency to try again to take the process objects out of the safe locker, using means such as a voice guidance. Next, the safe apparatus 10 sends safe storage information including information related to the collection to the safe management server 41 (Step S21). The safe storage information includes the collection and delivery agency number, the safe number specifying a safe locker, the consignment number, and the client number.

The safe management server 41 updates a corresponding entry included in the progress information database based on the received safe storage information (Step S22). In this case, an entry matching the consignment number and/or client number included in the safe storage information is searched, and ‘progress information’ in the entry is set as ‘2. in collection and delivery’. The safe management server 41 performs such a process for all the collected process objects. Subsequently, the safe management server 41 informs the client of the transaction progresses via the mail server (StepS23). In this case, a receiving location of the mail is a mail address of the client corresponding to the consignment number and the content of the mail is ‘in collection and delivery’.

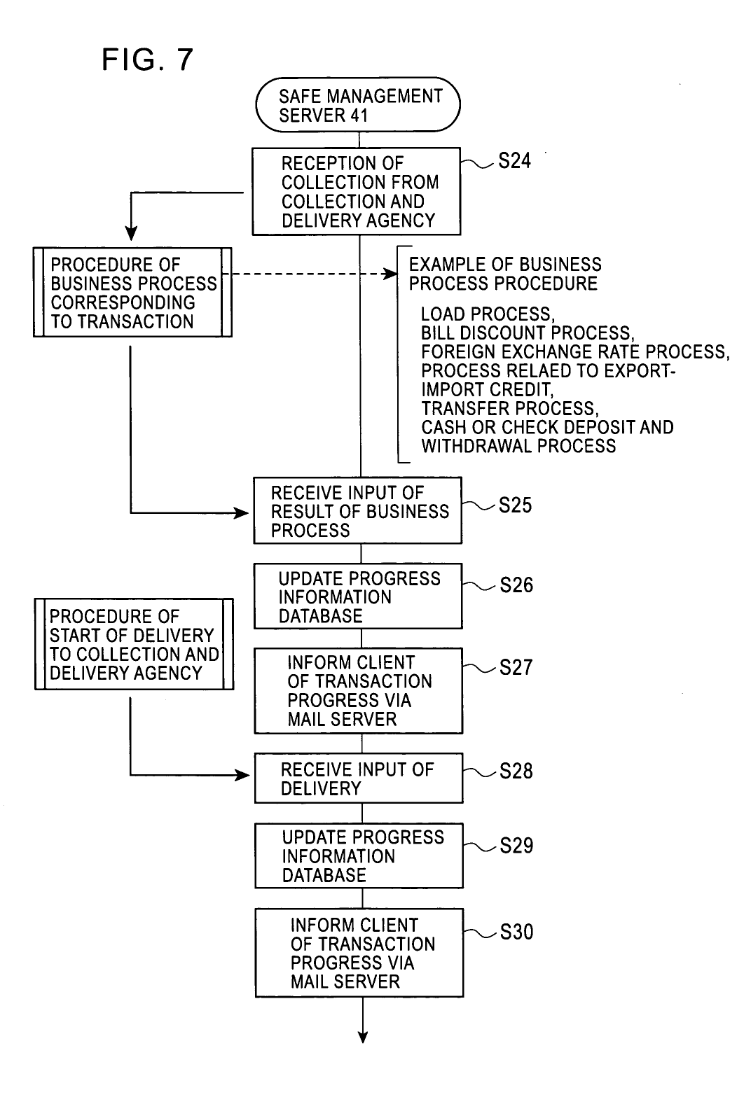

FIG. 7 illustrates a processing procedure of the entire system in a business processing phase in the business processing center. First, the business processing center receives the process objects collected from the safe apparatus 10 by the collection and delivery agency, and then, the reception is registered in a business processing terminal to perform reception of collection from the collection and delivery agency (Step S24). At this time, using a reader/writer for writing information in an IC tag or reading information from the IC tag, the process objects can be easily identified by reading the consignment number from the IC tags attached to the process objects. The respective process objects are processed depending on transaction contents of the process objects. For example, in the case of a cash deposit process, a business process of depositing cash in an account is performed by a bank clerk. Subsequently, by inputting results of the business process to the business process terminal, the safe management server 41 accepts the input of the results of the business process (Step S25). Information on the results of the business process includes at least the consignment number and the process completion.

Next, the safe management server 41 updates the contents of the progress information database based on the results of the business process (Step S26). In this case, an entry matching the consignment number included in the safe storage information is searched, and ‘progress information’ in the entry is set as ‘3. business process end’. The above process procedures are performed whenever processes for all articles are ended. Subsequently, the safe management server 41 informs the client of current transaction progresses via the mail server (Step S27). In this case, a receiving location of the mail is a mail address of the client corresponding to the consignment number and the content of the mail is ‘business process end’.

In the business process center, the “process results” obtained by the business process are taken over to the collection and delivery agency that performs a delivering operation to return the process results to the safe. The collection and delivery agency returns the process results to a business office containing an appropriate safe. Here, the safe management server 41 accepts the circumstances of the delivery start through an input of the delivery start from the business process terminal (Step S28). Based on the input of the delivery start, the safe management server 41 updates the contents of the progress information database (Step S29). In this case, an entry matching the consignment number included in the safe storage information is searched, and ‘progress information’ in the entry is set as ‘4. in delivery’. The above process procedures are performed for all the process results. Subsequently, the safe management server 41 informs the client of current transaction progresses via the mail server (Step S30). In this case, a receiving location of the mail is a mail address of the client corresponding to the consignment number and the content of the mail is ‘in delivery’.

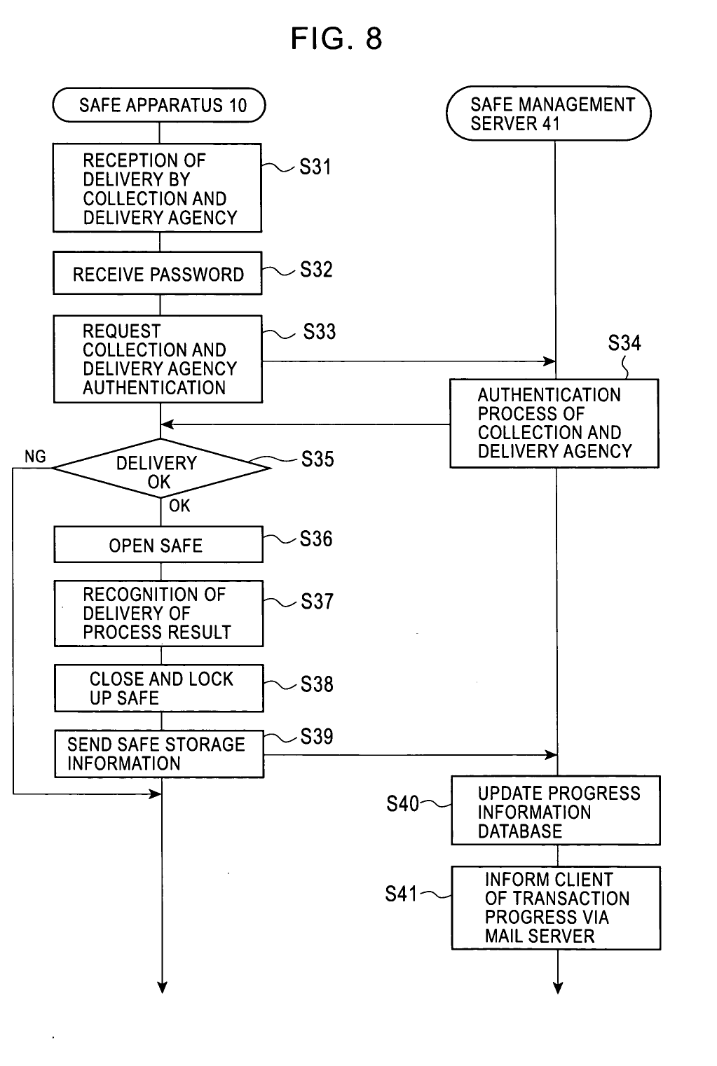

FIG. 8 illustrates a processing procedure of the entire system in a delivery phase by the collection and delivery agency. Referring to the figure, first, the safe apparatus 10 performs reception of delivery from the collection and delivery agency according to collection notification from the collection and delivery agency (Step S31). The delivery notification from the collection and delivery agency is recognized through a delivery notification operation using the touch panel connected to the safe apparatus 10. Subsequently, the safe apparatus 10 and the safe management server 41 perform an authentication process by the password of the collection and delivery agency (Steps S32, S33 and S34). Methods of the collection and delivery agency authentication process may include various methods in addition to a password method in the same way as the above collection phase.

According to the result of the authentication process from the safe management server 41, the safe apparatus 10 determines whether the delivery is accepted (OK) or not (NG) (Step S35). If the authentication result is NG, subsequent steps are skipped to stop the delivery. On the contrary, if the authentication result is OK, the safe apparatus 10 unlocks a safe locker in which the process results are to be put according to an electrical command and opens a door of the safe locker (Step S36). The collection and delivery agency puts the process results corresponding to the opened safe locker.

When the process results are put in the safe locker, the safe apparatus 10 checks whether the process results are correctly put in the safe locker using a detecting means such as an infrared ray sensor (Step S37). Subsequently, the safe locker is closed and locked according to an electrical command (Step S38). If the process results are incorrectly put in the safe locker, the safe apparatus 10 may urge the collection and delivery agency to properly operate by using means such as voice guidance. At this time, using a reader/writer for writing information in an IC tag or reading information from the IC tag, the process results can be easily identified by reading the consignment number from the IC tags attached to the process results. Next, the safe apparatus 10 sends safe storage information including information related to the delivery to the safe management server 41 (Step S39).

The safe management server 41 updates a corresponding entry included in the progress information database based on the safe storage information received from the safe apparatus 10 (Step S40). In this case, ‘progress information’ in the entry is set as ‘5. within the safe (process completion)’. The safe management server 41 performs such a process for all the delivered process results. Subsequently, the safe management server 41 informs the client of the transaction progresses via the mail server (Step S41). In this case, the content of the mail is ‘within the safe (process completion)’.

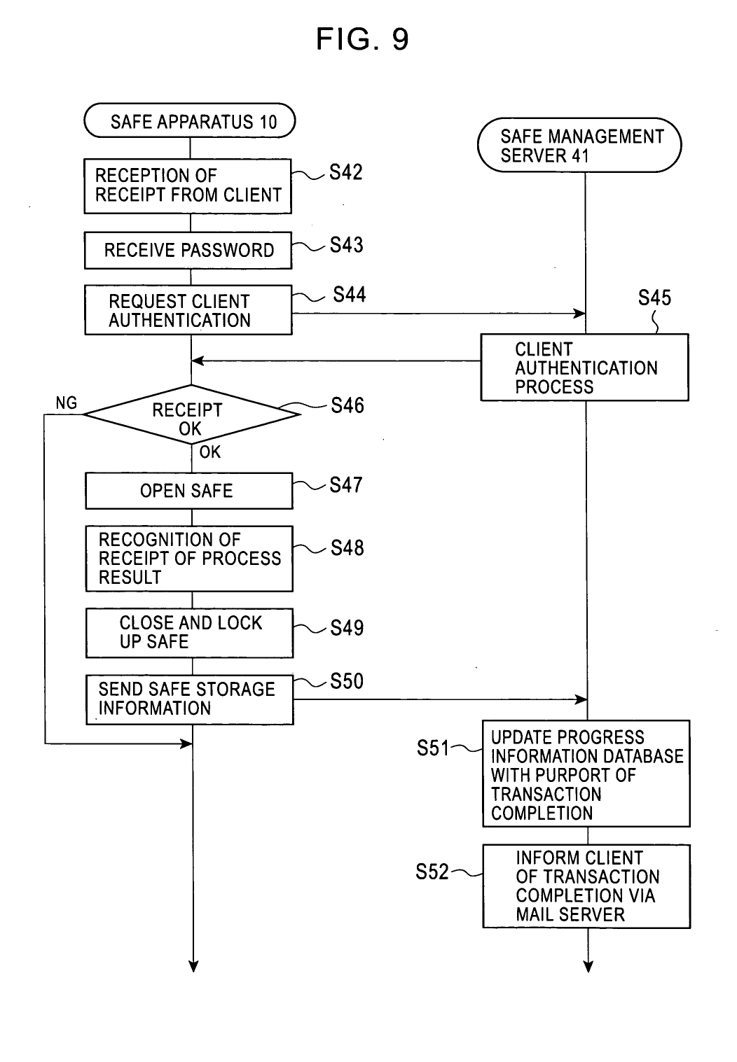

FIG. 9 illustrates a processing procedure of the entire system in a transaction termination phase by the client. Referring to the figure, first, the safe apparatus 10 accepts a receipt from the client according to a request for receipt from the client (Step S42). The receipt request from the client is recognized through a receipt request operation using the touch panel connected to the safe apparatus 10. Subsequently, the safe apparatus 10 and the safe management server 41 perform an authentication process by the password of the client (Steps S43, S44 and S45). Methods of the client authentication process may include various methods in addition to a password method in the same way as the transaction start phase.

According to the result of the authentication process from the safe management server 41, the safe apparatus 10 determines whether the transaction termination is accepted (OK)or not (NG) (Step S46). If the authentication result is NG, subsequent steps are skipped to stop the transaction termination. On the contrary, if the authentication result is OK, the safe apparatus 10 unlocks a safe locker assigned to the client according to an electrical command and opens a door of the safe locker (Step S47). The client receives the process results processed in the business processing center from the opened safe locker.

When the process results are taken out of the safe locker, the safe apparatus 10 checks whether the process results are correctly taken out of the safe locker using a detecting means such as an infrared ray sensor (Step S48). Subsequently, the safe locker is closed and locked according to an electrical command (Step S49). If the process results are not taken out of the safe locker, the safe apparatus 10 preferably prompts the client to try again to put the process results in the safe locker, using means such as voice guidance. Next, the safe apparatus 10 sends safe storage information to the safe management server 41 (Step S50).

The safe management server 41 updates a corresponding entry included in the progress information database with the purport of transaction termination by the receipt of the client, based on the safe storage information received from the safe apparatus 10 (Step S51). In this case, ‘progress information’ in the entry is set as ‘6. receipt completion’. The safe management server 41 performs such a process for all the delivered process results. Subsequently, the safe management server 41 informs the client of the transaction progresses via the mail server (Step S52). In this case, the content of the mail is ‘receipt completion’. One transaction is completed by performing a series of process procedures as described above.

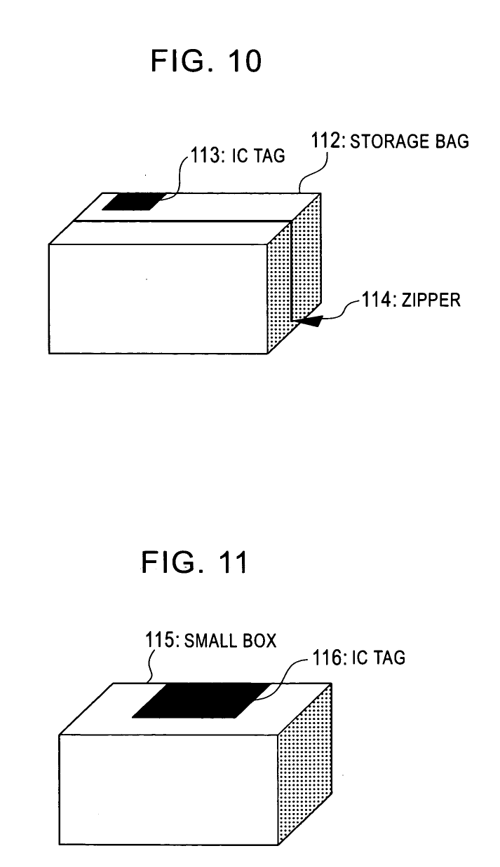

FIG. 10 illustrates an example of a modified safe apparatus in which the process objects or the process results are put in a storage bag and the storage bag is stored in the safe. A storage bag 112 is a bag in which cash, transaction slips, and securities are accommodated, and can be opened/closed by a zipper 114. The storage bag 112 may have an IC tag 113 for reading or recording the information such as the consignment number, the client number, the client mail address, the location of the used safe, the safe number, etc.

FIG. 11 illustrates an example of a modified safe apparatus in which individual safe lockers can be freely transported. A small box 115 can accommodate cash, transaction slips, and securities. The small box 115 may have an IC tag 116 for reading or writing information. The information stored in the IC tag 116 includes at least the consignment number, the client number, the safe number, and safe lock control information. The safe lock control information allows only clients and bank clerks of financial institutions to lock and unlock the small box 115. By making a freely transferable small box 115 of the safe locker in the above-described embodiment, security can be enhanced since the collection and delivery agency does not have direct contact with the process objects and the process results.

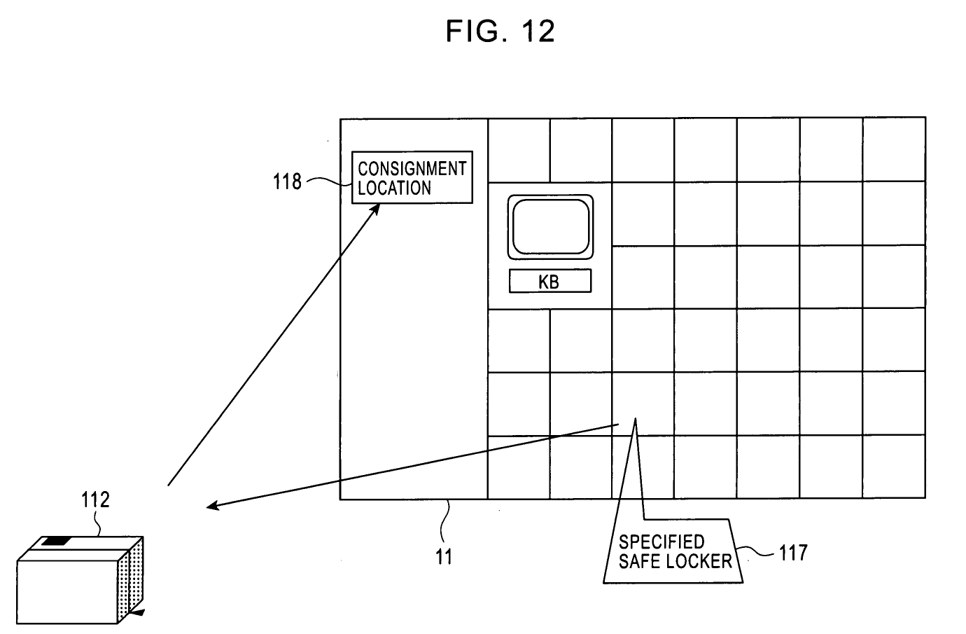

FIG. 12 illustrates a further example of a modified safe apparatus in which the storage bag shown in FIG. 10 is received and passed. Specifically, a safe unit 11 is composed of the plurality of safe lockers (for example, a safe locker 117 shown as one of the plurality of safe lockers), which is similar to those described above, and one consignment location 118. In operation of the safe unit 11, the client stores the process objects for transaction in the storage bag 112 and always throws the storage bag 112 in the consignment location 118. The process results corresponding to the transaction, which are arranged through the business process in the business processing center, are returned to the client by the safe locker 117 specified for each transaction in the same way as in the above description.

As another modification of the invention, the safe management server may manage empty safes and secure one empty safe in advance by a reservation from the client such that the client can surely use the empty safe. In addition, according to a request from the client, the process in which results to be returned to the client may be stored in a safe in a business office at a location other than the location at which the business office where a transaction begins is located. This method allows the client to complete the transaction at a desired location, thereby contributing to the client's convenience.

As yet another modification of the invention, a linkage with an automatic teller machine (ATM) may be considered. It may be considered that an ATM capable of conducting data communication with a counting system of a financial institution is used to deliver and receive cash and the transaction support system according to the invention may also be used to deliver and receive documents. This can provide higher security for cash transaction.

Although the business processing center plays a central part in the report of the progress information to the client in the above-described embodiment, the safe apparatus 10 may directly report up-to-date progress information in the safe apparatus 10 to the client.

Typically, the plurality of safes installed at the business offices belongs to one financial institution. However, the invention is not limited to this, and may retain the plurality of safes as a common safe and temporarily assign one safe to the client and a financial institution having business relation with the client for each transaction.

A safe use system of the invention is applicable to not only financial institutions such as banks but also finance-related companies such as securities companies and insurance companies.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2004-204100 which is hereby incorporated by reference.

What is claimed is:

1. A transaction support method for supporting a transaction by controlling opening/closing of a plurality of lockers in order to deliver and receive articles related to the transactions, the transaction support method comprising:
a safe preparation step of preparing each of the plurality of lockers as a safe;
a client determination step of determining whether a client is an authorized client based on pre-stored client-related information in accordance with a request for transaction from the client;
a safe assignment step of assigning one of the plurality of safes as an assignment safe to the client if it is determined that the client is an authorized client; and
an unlock step of unlocking the assignment safe.

2. The transaction support method according to claim 1, further comprising:
a collection and delivery agency determination step of determining whether a collection and delivery agency is an authorized collection and delivery agency based on pre-stored collection and delivery agency-related information in accordance with a request from the collection and delivery agency transferring the articles between facilities at which business processes of the transaction are performed; and
an unlock step of unlocking the assignment safe if it is determined that the collection and delivery agency is an authorized collection and delivery agency.

3. The transaction support method according to claim 1, further comprising:
a progress information preparation and update step of preparing or updating progress information for each transaction on the basis of input information according to the progress of the transaction; and
a progress notification step of notifying the client of the progress information at a predetermined timing.

4. The transaction support method according to claim 3, wherein the input information according to the progress of the transaction is any one of a detecting signal of the article in the assignment safe and input information by an operator.

5. The transaction support method according to claim 4, wherein the input information by the operator includes result information of business process for the article.

6. The transaction support method according to claim 1, wherein the client determination step is a step of determining the client on the basis of any one of a password and bio-information of the client.

7. The transaction support method according to claim 2, wherein the collection and delivery determination step is a step of determining the collection and delivery agency based on any one of a password or bio-information of the collection and delivery agency.

8. The transaction support method according to claim 1, wherein the safe assignment step includes a step of assigning the assignment safe to the client in advance according to a request for reservation from the client.

9. The transaction support method according to claim 1, further comprising:
a lock step of locking the assignment safe in accordance with putting/taking the article in/out of the assignment safe.

10. The transaction support method according to claim 1, wherein the article is put in a storage bag including an information medium, from/on which information related to the transaction can be freely read and written.

11. The transaction support method according to claim 1, wherein the safe can be freely transferred.

12. The transaction support method according to claim 11, wherein the safe includes an information medium from/on which information related to the transaction can be freely read and written.

13. The transaction support method according to claim 1, further comprising a monitor step of monitoring security of the safe.

14. A transaction support system for supporting a transaction by controlling opening/closing of a plurality of lockers in order to deliver and receive articles related to the transactions, comprising:
safe accommodation means for accommodating each of the plurality of lockers as a safe;
client determination means for determining whether a client is an authorized client based on pre-stored client-related information in accordance with a request for transaction from the client;
safe assignment means for assigning one of the plurality of safes as an assignment safe to the client if it is determined that the client is an authorized client; and
unlock means for unlocking the assignment safe.

15. The transaction support system according to claim 14, further comprising:
collection and delivery agency determination means for determining whether a collection and delivery agency is an authorized collection and delivery agency based on pre-stored collection and delivery agency-related information in accordance with a request from the collection and delivery agency who transfers the articles between facilities at which business processes of the transaction are performed; and
unlock means for unlocking the assignment safe if it is determined that the collection and delivery agency is an authorized collection and delivery agency.

16. The transaction support system according to claim 14, further comprising:
progress information preparation and update means for preparing or updating progress information for each transaction based on information inputted according to the progress of transaction; and
progress notification means for notifying the client of the progress information at a predetermined timing.
